(19) United States
(12) Patent Application Publication
(10) Pub. No.: US 2026/0184090 A1
(43) Pub. Date: Jul. 2, 2026

(54) PRINTER

(71) Applicant: STAR MICRONICS CO., LTD., SHIZUOKA (JP)

(72) Inventor: Yusuke SONE, SHIZUOKA (JP)

(21) Appl. No.: 19/427,326

(22) Filed: Dec. 19, 2025

(30) Foreign Application Priority Data
Dec. 26, 2024 (JP) 2024-229708

(51) Int. Cl. B41J 11/70; B41J 3/407; B41J 11/04; B41J 11/66; B41J 15/04; B41J 15/16

(52) U.S. Cl. CPC B41J 11/703; B41J 3/4075; B41J 11/04; B41J 11/663; B41J 15/048; B41J 15/16

(57) ABSTRACT

To provide an inexpensive printer that suppresses the occurrence of paper jams.

A printer includes: a platen roller configured to feed linerless label paper having an adhesive surface on a side opposite to a printing surface on which printing is to be performed, the adhesive surface being coated with an adhesive; a print head configured to perform printing on the linerless label paper being fed by the platen roller; and a cutting device having a fixed blade and a movable blade. The movable blade 621 advances from the adhesive surface side of the linerless label paper toward the fixed blade, and a surface of the movable blade on a downstream side in a paper feed direction faces a surface of the fixed blade on an upstream side in the paper feed direction.

### CROSS-REFERENCES

The application claims priority of Japanese Patent Application No. 2024-229708 filed on Dec. 26, 2024. The contents of this application are incorporated herein by reference in their entirety.

### BACKGROUND OF THE INVENTION

### 1. Field of the Invention

The present invention relates to a printer including a cutting device for cutting paper.

### 2. Description of the Related Art

A printer is known that feeds paper having an adhesive surface coated with an adhesive, performs printing on a printing surface opposite the adhesive surface, and cuts the printed paper with a cutting device (e.g., see Japanese Patent Application Publication No. 2008-68565). The cutting device of the printer described in Japanese Patent Application Publication No. 2008-68565 has a movable blade and a fixed blade, and cuts the paper by the movable blade advancing toward the fixed blade. This movable blade is positioned on the printing surface side of the paper and is configured to advance downstream in the paper feed direction from the fixed blade while pressing and contacting the cutting edge of the fixed blade positioned on the adhesive surface side, which is a non-printing surface side. Positioning the movable blade on the printing surface side makes it less likely for the adhesive to adhere to the movable blade even with repeated cutting, so that sticking between the movable blade and the paper can be prevented for a long period of time. In addition, advancing the surface of the movable blade on the downstream side so as to face the upstream surface of the fixed blade makes it easy to maintain the tension of the paper during cutting, so that the paper can be prevented from getting caught between the movable blade and the fixed blade and resulting in poor cutting. For such reasons, the above configuration is generally adopted in cutting devices for printers that handle sheets of paper having adhesive surfaces.

### SUMMARY OF THE INVENTION

However, there are cases where the movable blade cannot be positioned on the printing surface side due to limitations on the overall printer layout, and in such cases the fixed blade is positioned on the printing surface side and the movable blade is positioned on the adhesive surface side. However, positioning the movable blade on the adhesive surface side makes it more likely for the adhesive to adhere to the movable blade, so that the adhesive surface of the leading end portion of paper on the upstream side that has been separated from paper on the downstream side by cutting may stick to the adhesive that has adhered to the movable blade. This causes a problem that, if the next printing is started and then the paper located on the upstream side is fed with the leading end portion of the paper still stuck to the movable blade, a paper jam will occur. To address this problem, in the case where the movable blade is positioned on the adhesive surface side, it is possible to apply an expensive coating to the movable blade that makes it difficult for the adhesive to adhere to the movable blade, or to provide a device that applies oil to the movable blade. However, this leads a problem that results in the printer becoming expensive.

The present invention has been made in consideration of the above-described problems, and an object thereof is to provide an inexpensive printer that suppresses the occurrence of paper jams.

To solve the above-described problems, a printer according to the present invention includes:
a feeding means configured to feed paper having an adhesive surface on a side opposite to a printing surface on which printing is to be performed, the adhesive surface being coated with an adhesive;
a print head configured to perform printing on the paper being fed by the feeding means; and
a cutting device having a fixed blade and a movable blade,
wherein the movable blade advances from the adhesive surface side of the paper toward the fixed blade, and a surface of the movable blade on a downstream side in a paper feed direction faces a surface of the fixed blade on an upstream side in the paper feed direction.

With this printer, the adhesive is less likely to adhere to the surface of the movable blade on the upstream side, without the need for a device for applying an expensive coating on the movable blade or applying oil to the movable blade, and therefore, the risk of the leading end of the paper located on the upstream side sticking to the adhesive that has adhered to the movable blade is reduced and the occurrence of paper jams is suppressed.

As used herein, the fixed blade may have a cutting edge formed on an edge of its surface on the upstream side. The movable blade may have a cutting edge formed on an edge of its surface on the downstream side. The movable blade may be configured to cut the paper while pressing and contacting the cutting edge of the fixed blade. The feeding means may be configured to feed paper having an exposed adhesive surface.

This printer may include
a detection means positioned on the downstream side from a cutting position by the cutting device and configured to detect whether or not a cut portion of the paper cut by the cutting device has been removed from the printer, and
the feeding means may be configured to feed an uncut portion of the paper toward the downstream side from the cutting position after the detection means detects that the cut portion has been removed.

By configuring so, the cut portion and the uncut portion are prevented from sticking together, so that the occurrence of paper jams can be more reliably suppressed.

In this printer,
the feeding means may have a platen positioned facing the print head, and
the print head may be configured to perform printing on the paper that is interposed between the print head and the platen.

Since the paper is interposed between the print head and the platen, the uncut portion located on the upstream side from the cutting position will not unintentionally move to the downstream side from the cutting position. Even if an adhesive has adhered to the surface of the movable blade on the downstream side, this configuration makes it possible to prevent the adhesive surface of the uncut portion from sticking to the adhesive that has adhered to the movable blade.

Furthermore, in this printer,
the feeding means may be configured to feed the paper pulled out from a roll of paper wound with the adhesive surface facing inward.

A paper tends to curl in a direction that curves toward its adhesive surface, and accordingly, the leading end portion of the paper tends to move away from the fixed blade. Even if an adhesive has adhered to the surface of the fixed blade on the upstream side, this configuration makes it possible to prevent the adhesive surface of the uncut portion from sticking to the adhesive that has adhered to the fixed blade.

According to the present invention, it is possible to provide an inexpensive printer that suppresses the occurrence of paper jams.

### BRIEF DESCRIPTION OF THE DRAWINGS

FIG. 1 is a perspective view of a printer corresponding to an embodiment of the present invention, viewed from diagonally above;

FIG. 2 is a cross-sectional view of the printer illustrated in FIG. 1, cut at the center in the width direction and viewed from the right side of the printer;

FIG. 3 is a cross-sectional view similar to FIG. 2, illustrating a state in which a movable blade has advanced;

FIG. 4 is a block diagram illustrating a control configuration of the printer illustrated in FIG. 1;

FIG. 5 is a flowchart illustrating a printing operation of the printer illustrated in FIG. 1; and

FIG. 6 is an explanatory diagram explaining font conversion in the printer illustrated in FIG. 1.

### DETAILED DESCRIPTION

An embodiment of the present invention will be described below with reference to the drawings. The present embodiment will be described by way of example, as a thermal printer configured to: pull out linerless label paper from a roll of paper formed by winding into a roll a long piece of linerless label paper having a printing surface that changes color when heated and an adhesive surface coated with an adhesive; perform printing on the paper; and then cut the resulting paper. This linerless label paper corresponds to an example of paper.

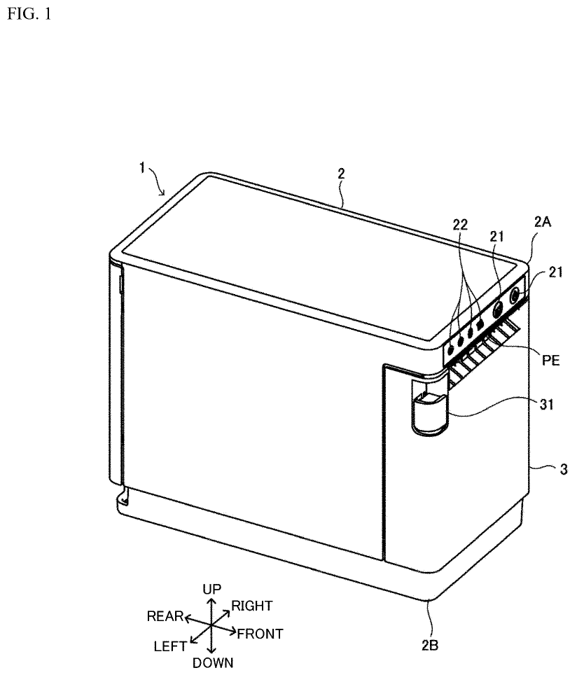

FIG. 1 is a perspective view of a printer 1 corresponding to an embodiment of the present invention, viewed obliquely from above.

In FIG. 1, the lower left side of the figure is the left side of the printer 1, the upper right side of the figure is the right side of the printer 1, the lower right side of the figure is the front side of the printer 1, and the upper left side of the figure is the rear side of the printer 1. In the following description, the left-right direction of the printer 1 is sometimes herein referred to as the width direction.

As illustrated in FIG. 1, the printer 1 includes a printer body 2 and a cover 3. FIG. 1 illustrates the printer 1 in a cover-closed state where the cover 3 is closed. The printer body 2 has an opening (not illustrated) on a front surface portion, and is box-shaped with an upper protrusion 2A and a lower protrusion 2B formed at top and bottom portions of the front surface, respectively, which protrude forward beyond the opening. The printer body 2 has two operation buttons 21 and four indicators 22 on the front surface of the upper protrusion 2A. The operation buttons 21 correspond to an example of an operation unit. The four indicators 22 indicate the status of the printer 1 by lighting on or off, or blinking.

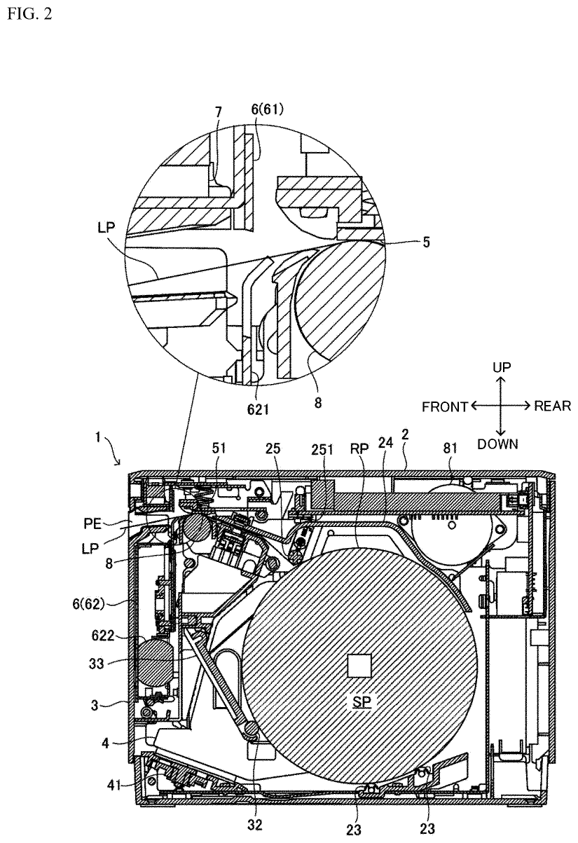

The cover 3 is attached to the printer body 2 so as to be rotatable about a front lower portion of the printer body 2 as the center of rotation. The cover 3 rotates to change its position between a closed position and an open position. The cover 3 is provided with a cover open lever 31. When the cover open lever 31 of the cover 3 in the closed position is pulled, the cover 3 rotates to change its position to the open position. When a portion opposite the center of rotation of the cover 3 in the open position is lifted and pressed against the printer body 2, the cover 3 changes its position to the closed position. As illustrated in FIG. 1, a paper ejection port PE through which printed linerless label paper LP (see FIG. 2) is ejected is formed between an upper end of the cover 3 in the closed position and a lower end of the upper protrusion 2A of the printer body 2.

FIG. 2 is a cross-sectional view of the printer 1 illustrated in FIG. 1, cut at the center in the width direction and viewed from the right side of the printer 1. FIG. 2 illustrates the printer 1 with the cover 3 being in the closed position. In the following description, unless otherwise specified, the positional relationship between the components will be described on the basis of a state where the cover 3 is in the closed position.

As illustrated in FIG. 2, inside of the printer body 2, a storage space SP is formed for storing a roll of paper RP. FIG. 2 illustrates the roll of paper RP stored in the storage space SP. Also illustrated in FIG. 2 is the linerless label paper LP that has been pulled out from the roll of paper RP. This roll of paper RP is formed by winding up the linerless label paper LP, which has a printing surface on which printing is to be performed and an adhesive surface coated with an adhesive on the opposite side to the printing surface, into a roll so that the printing surface is on the outside and the adhesive surface is on the inside. In the storage space SP, the roll of paper RP is stored so as to be rotatable.

The printer 1 includes a print head 5, a cutting device 6, a paper sensor 7, and a platen roller 8. This platen roller 8 corresponds to an example of a platen and also corresponds to an example of a feeding means. The cutting device 6 has a fixed blade 61 and a movable blade unit 62. Of these, the print head 5, the fixed blade 61, and the paper sensor 7 are mounted to the printer body 2. The platen roller 8 and the movable blade unit 62 are mounted to the cover 3. The print head 5 and the platen roller 8 make up a printing mechanism.

The print head 5 is positioned facing the platen roller 8 and is pressed against the platen roller 8 by a head spring 51. As illustrated in FIG. 2, when the linerless label paper LP is present between the print head 5 and the platen roller 8, the linerless label paper LP is interposed between the print head 5 and the platen roller 8. The movable blade unit 62 is provided with a movable blade 621. When the movable blade 621 has not advanced, the movable blade 621 and the fixed blade 61 face each other across a paper feed path. When the cover 3 is in the open position, the platen roller 8 is positioned at a distance from the print head 5, and the movable blade 621 is positioned at a distance separated from the fixed blade 61.

A path that connects the storage space SP, passing between the print head 5 and the platen roller 8 and between the fixed blade 61 and the movable blade 621, to the paper ejection port PE forms the paper feed path of the printer 1. A direction from the storage space SP toward the paper ejection port PE is the paper feed direction. The linerless label paper LP in the paper feed path is fed mainly to the downstream side in the paper feed direction as the platen roller 8 rotates, and is ejected toward the front of the printer 1 from the paper ejection port PE.

The print head 5 is a so-called thermal print head having a plurality of heating elements arranged in the width direction of the printer 1 (the direction perpendicular to the paper surface in FIG. 2). The print head 5 is positioned on the printing surface side of the linerless label paper LP that has been pulled out from the roll of paper RP and is located in the paper feed path. By selectively heating the plurality of heating elements while feeding the linerless label paper LP, printing is performed on the linerless label paper LP interposed between the print head 5 and the platen roller 8. Hereinafter, a portion of the linerless label paper LP on which printing has been performed is sometimes herein referred to as the printed portion.

The cutting device 6 is a so-called guillotine-type electric cutter. The fixed blade 61 is fixed to the printer body 2 at a position facing the printing surface of the linerless label paper LP in the paper feed path. In other words, the fixed blade 61 is fixed to the printer body 2 above the paper feed path. The fixed blade 61 has a rectangular plate shape, and has a cutting edge formed extending in the printer width direction as a portion that is an edge of the surface on the upstream side in the paper feed direction (the right side in FIG. 2) and that corresponds to the long side of the rectangle. Hereinafter, the upstream side in the paper feed direction is sometimes herein simply referred to as the upstream side, and the downstream side in the paper feed direction is sometimes herein simply referred to as the downstream side. The cutting edge of the movable blade 621 comes into sliding contact with the cutting edge of the fixed blade 61.

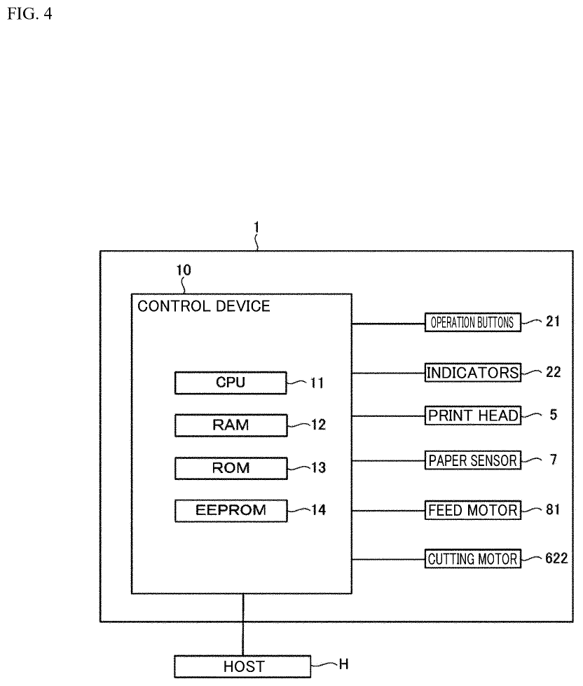

The movable blade unit 62 is provided with the movable blade 621 described above and a cutting motor 622. The movable blade 621 has a plate-like shape with a V-shaped cutting edge formed on the upper edge of the surface on the downstream side (the left side in FIG. 2) that is inclined so as to be located in a direction away from the fixed blade as it runs from both ends in the width direction toward the center in the width direction. The movable blade 621 can move in an advancing direction toward the fixed blade 61 and in a retreating direction away from the fixed blade 61, and moves in the advancing and retreating directions by the cutting motor 622 driven. The cutting by the cutting device 6 includes full cutting that cuts the entire linerless label paper LP in the width direction, and partial cutting that cuts the linerless label paper LP with a slight part left in the width direction. The full cutting is achieved by advancing the movable blade 621 toward the fixed blade 61 until the entire cutting edge of the movable blade 621 intersects with the cutting edge of the fixed blade 61. On the other hand, the partial cutting is achieved by retreating the movable blade 621 from the fixed blade 61 just before the widthwise center of the cutting edge of the movable blade 621 intersects with the cutting edge of the fixed blade 61. The user of the printer 1 has selected whether to perform the full cutting or the partial cutting using the operation buttons 21 (see FIG. 1) or a host H (see FIG. 4), and the selection has been stored in an EEPROM 14.

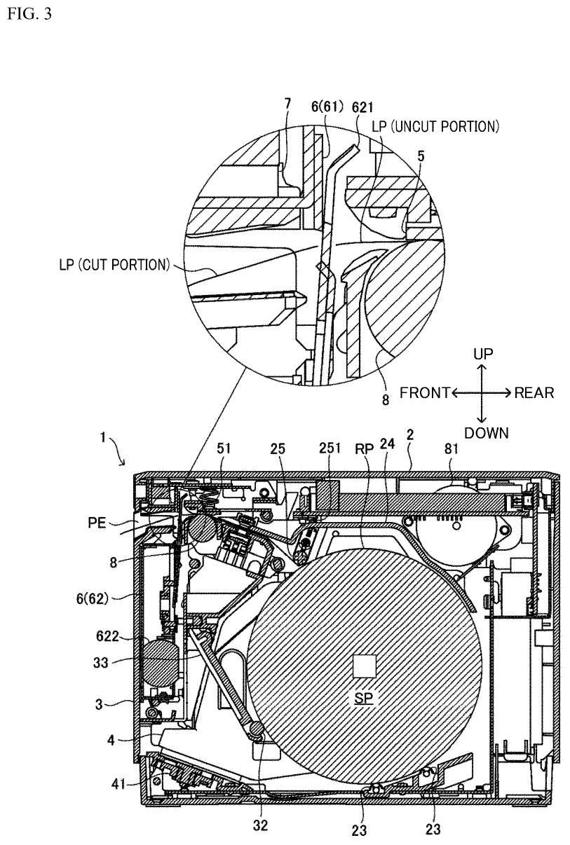

FIG. 3 is a cross-sectional view similar to FIG. 2, illustrating a state in which the movable blade 621 has advanced.

After the printed portion is fed to the downstream side from between the movable blade 621 and the fixed blade 61, when the cutting motor 622 is driven, the movable blade 621 advances from the lower side, which is the adhesive surface side of the linerless label paper LP, toward the fixed blade 61 located above as illustrated in FIG. 3. The movable blade 621 advances along the surface of the fixed blade 61 on the upstream side while overlapping that surface on the upstream side. As a result of the advancement, the surface of the movable blade 621 on the downstream side faces the surface of the fixed blade 61 on the upstream side. During the process of the advancement, the movable blade 621 is elastically pressed against the fixed blade 61 located on the downstream side by the pressing mechanism. As a result, the movable blade 621 advances while the cutting edge of the movable blade 621 and the cutting edge of the fixed blade 61 are pressed against each other, and the printed portion is cut off from the linerless label paper LP on the upstream side from the cutting position where the cutting edges intersect. Hereinafter, the printed portion that has been cut off from the linerless label paper LP on the upstream side by cutting is sometimes herein referred to as the cut portion. The linerless label paper LP remaining on the upstream side from the cutting position when the cut portion is separated by cutting is sometimes herein referred to as the uncut portion. For the partial cutting, the cut portion and the uncut portion are connected over a distance of about several millimeters in a widthwise center portion. The movable blade 621 retreats immediately after completing the advancing motion, and retreats to the initial position spaced apart from the fixed blade 61 as illustrated in FIG. 2.

The paper sensor 7 is a reflective photosensor that includes a light emitting element and a light receiving element. This paper sensor 7 corresponds to an example of a detection means. The leading end of the cut portion cut by the fixed blade 61 and the movable blade 621 is exposed to the outside of the printer 1 from the paper ejection port PE, and the trailing end remains inside of the printer 1. The paper sensor 7 is positioned on the downstream side from the cutting position by the cutting device 6 and in the vicinity of the paper ejection port PE, and detects whether or not the cut portion cut by the fixed blade 61 and the movable blade 621 has been removed from the printer 1. Specifically, the paper sensor 7 detects whether or not the cut portion has disappeared in the vicinity of the paper ejection port PE, which is a detection position, thereby detecting whether or not the cut portion has substantially been removed from the printer 1. In addition to the paper sensor 7, the printer 1 also includes a black mark sensor made up of a reflective photosensor for detecting black marks on paper; and a label gap sensor made up of a transmissive photosensor for detecting the leading end position of a label.

The platen roller 8 is positioned facing the heating elements of the print head 5 on the adhesive surface side of the linerless label paper LP in the paper feed path. The platen roller 8 is a roller having an axis extending in the width direction, rotates when a feed motor 81 is driven, and with the rotation, feeds the linerless label paper LP interposed between the platen roller 8 and the print head 5 along the paper feed direction. A feeding means other than the platen roller 8, such as a roller pair, may be provided.

Four body rollers 23 are provided on the inner bottom surface of the printer body 2 in a lower end portion of the storage space SP. In FIG. 2, of the four body rollers 23, two body rollers 23 arranged on the left side of the printer 1 are illustrated. The four body rollers 23 have the same cylindrical shape, and are each rotatably supported by a roller support portion formed on the bottom surface of the printer body 2. On the right side of the printer 1, the remaining two body rollers 23 are arranged at the same positions in the front-rear and up-down directions as the two body rollers 23 arranged on the left side. Of the four body rollers 23, the two body rollers 23 located on the rear side are positioned slightly above the two body rollers 23 located on the front side to conform to the shape of the roll of paper RP stored in the storage space SP.

A top plate member 24 is fixed to an upper end portion of the storage space SP in the printer body 2. The top plate member 24 is provided with a tensioning member 25. The tensioning member 25 is biased downward by a tension spring 251. The tensioning member 25 prevents the tension of the linerless label paper LP pulled out from the roll of paper RP from fluctuating excessively.

The cover 3 is provided with a cover roller 32 and a roller moving mechanism 33. The cover roller 32 has a cylindrical shape similar to that of the body roller 23. The cover roller 32 is attached to the roller moving mechanism 33 so as to be rotatable. When the cover 3 is in the closed position, the cover roller 32 is positioned in a protruding position where it protrudes from the cover 3 toward the storage space SP. This protruding position is a position where the cover roller 32 comes into contact with the outer circumferential surface of the roll of paper RP when the roll of paper RP stored in the storage space SP has at least a large diameter.

The roller moving mechanism 33 is attached to the cover 3 so as to be swingable. When the cover 3 is in the open position, the roller moving mechanism 33 swings (rotates) clockwise in FIG. 3 relative to when the cover 3 is in the closed position. As a result, the cover roller 32 is positioned at a retracted position where it is retracted to the cover 3 side. In this retracted position, the cover roller 32 is inserted inside of the cover 3. In this way, when the cover 3 is in the open position, the cover roller 32 moves to the retracted position, making it easy to insert and remove the roll of paper RP into and from the storage space SP.

When the cover 3 is in the closed position, the body rollers 23 and the cover roller 32 come into contact with the lower outer peripheral surface of the roll of paper RP stored in the storage space SP and rotate in response to the rotation of the roll of paper RP. This reduces the rotational resistance of the roll of paper RP, allowing the linerless label paper to be pulled out smoothly from the roll of paper RP, and making it possible to suppress failed feed of the linerless label paper LP caused by the rotational resistance of the roll of paper RP.

FIG. 4 is a block diagram illustrating a control configuration of the printer 1 illustrated in FIG. 1.

As illustrated in FIG. 4, the printer 1 includes a control device 10. The control device 10 includes a CPU 11, a RAM 12, a ROM 13, and the EEPROM 14. The RAM 12 is used as a work area for temporarily saving print data and others transmitted from the host H.

The ROM 13 stores a control program storing operations of the printer 1. The EEPROM 14 is a rewritable non-volatile memory, and stores various types of setting information such as paper settings.

The control device 10 is connected to the operation buttons 21, the indicators 22, the print head 5, the paper sensor 7, the feed motor 81, and the cutting motor 622. To the control device 10, print data and various commands are transmitted from the host H. While referring to the detection results of the paper sensor 7, the control device 10 controls the indicators 22, the print head 5, the paper sensor 7, the feed motor 81, and the cutting motor 622 in response to various commands from the host H and operations on the operation buttons 21, to feed the linerless label paper LP (see FIG. 2) and perform printing on the linerless label paper LP.

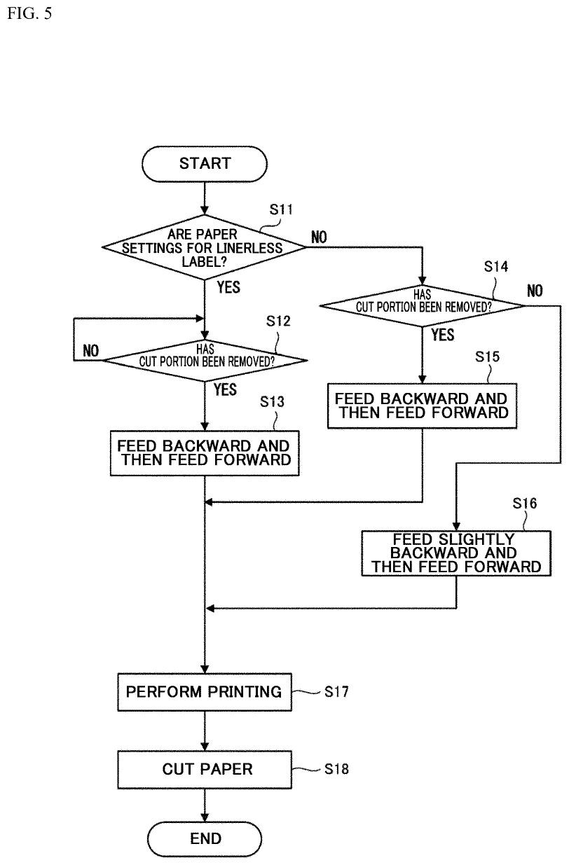

FIG. 5 is a flowchart illustrating a printing operation of the printer 1 illustrated in FIG. 1. This printing operation is executed by the control device 10 operating the printer 1 in accordance with a control program while referring to print data, various types of setting information, an output of the paper sensor 7, and the like.

As illustrated in FIG. 5, in the printing operation, it is first determined whether the paper settings are for linerless label paper or other type of paper (step S11). The paper settings include a type of paper to be used selected by the user of the printer 1 using the operation buttons 21 or the host H, and are stored in the EEPROM 14. In some cases, the type of paper may be selected using a physical switch such as a DIP switch instead of the EEPROM 14.

If the paper settings are for linerless label paper (YES in step S11), it is determined whether or not the cut portion has been removed from the printer 1, and if it has not been removed, the processing waits until it has been removed (step S12).

When the cut portion is removed from the printer 1 (YES in step S12), the paper (here, linerless label paper) is first fed backward and then fed slightly forward (step S13). The feeding backward refers to the motion of feeding the paper to the upstream side. By this feeding backward, the leading end of the paper is brought closer to the heating elements of the print head 5, thereby making it possible to reduce the margin at the top of the paper. The feed distance for the feeding backward can be set in the range of 1 mm or more and 11 mm or less, and the feed distance for the feeding forward can be set in the range of 1.5 mm or more and 3.5 mm or less, each in 0.5 mm intervals. These feed distances are set by the user of the printer 1 using the operation buttons 21 or the host H, and are stored in the EEPROM 14. This results in a margin length at the top of the paper 3 mm or more and 15 mm or less. Instead of the feed distances for the feeding backward and forward, the user of the printer 1 may set the margin length. In this case, the feed distances for the feeding backward and forward may be stored in advance in a memory such as the ROM 13 in correspondence with the combination of the margin length and the paper settings, and the feeding backward and forward may be executed by reading out those feed distances.

Even if an adhesive adheres to the downstream surface side of the fixed blade 61 and the printing surface of the paper sticks to the adhesive, the feeding backward makes it possible to peel off the paper from the adhesive that has adhered to the fixed blade 61. If a configuration is provided in which the surface of the movable blade 621 on the upstream side faces the surface of the fixed blade 61 on the downstream side as the movable blade 621 advances, the adhesive can easily adhere to the surface of the movable blade 621 on the upstream side. In that case, the adhesive that has adhered to the movable blade 621 may strongly stick to the adhesive surface of the paper, and even when the paper is fed backward, the adhesive will stretch and the sticking will not be easily released, increasing the possibility of a paper jam occurring in step S17 described below. The feeding forward performed after the feeding backward refers to a motion of feeding the paper very slightly to the downstream side. This feeding forward is a motion for removing backlash in a transmission mechanism such as a gear train for transmitting rotation from the feed motor 81 to the platen roller 8, and the feed distance for the feeding forward is extremely short. Therefore, in step S13, the uncut portion of the paper is not fed to the downstream side from the cutting position by the cutting device 6.

On the other hand, if the paper settings are not for linerless label paper (NO in step S11), it is determined whether or not the cut portion has been removed from the printer 1 (step S14).

If it is determined in step S14 that the cut portion has been removed (YES in step S14), the paper (in this example, a type of paper other than linerless label paper, such as die-cut paper, label paper with liner, or ordinary thermal paper) is first fed backward and then fed slightly forward (step S15). This motion in step S15 is similar to that in step S12, and the purpose thereof is also the same except for peeling the paper off from the fixed blade 61.

If it is determined in step S14 that the paper has not been removed (NO in step S14), the paper (in this example, a type of paper other than linerless label paper) is once fed backward and then fed slightly forward (step S16). The purpose of step S16 is the same as that of step S15, but the motion in step S16 is different from that in step S15 in that the feeding distance for the feeding backward is shorter in step S16 than in step S15. This is because if the previous paper cutting is partial cutting with a portion remaining uncut, the cut and uncut portions are connected to each other, and then if the paper is fed backward a long distance in this state, the cut portion may get caught in the cutting device, causing a paper jam.

After step S13, S15, or S16 is completed, the heating elements of the print head 5 are selectively heated to perform printing while the uncut portion of the paper is fed (step S17). In this step S17, the leading end of the uncut portion of the paper is fed to the downstream side from the cutting position by the cutting device 6. When the printing is completed and then the trailing end of the printed portion passes the cutting position, the feed of the paper is stopped and then the paper is cut (step S18). Thus, the printing operation ends. There are cases where the printer 1 receives a command to only feed paper without printing, and where the operation buttons 21 are operated to only feed paper. In such cases, the same operation as the printing operation are executed, except that the heating elements of the print head 5 are not turned on in step S17, and the paper is not cut in step S18. There are also cases where the printer 1 receives a cutting command, and where the operation buttons 21 are operated to perform cutting. In such cases, the paper is cut without being fed.

Next, conversion of fonts used for printing will be described.

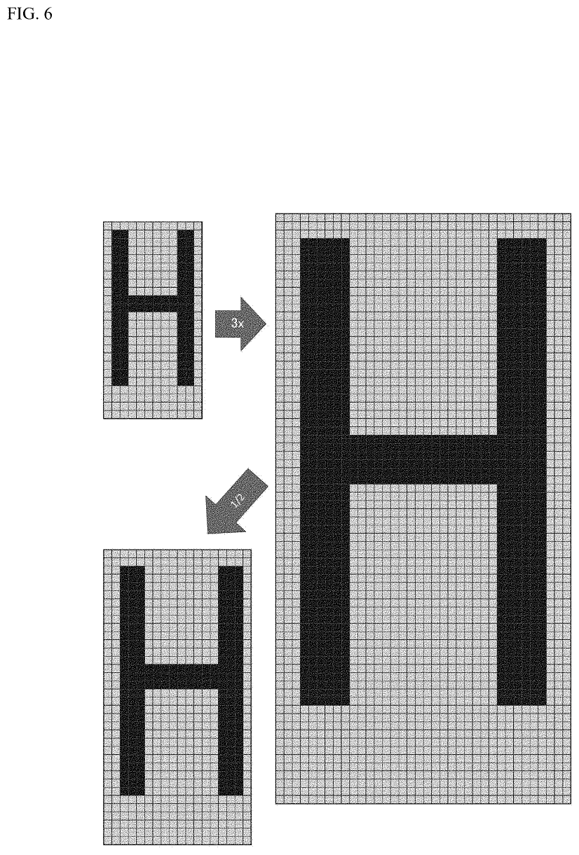

FIG. 6 is an explanatory diagram explaining font conversion in the printer 1 illustrated in FIG. 1.

A typical conventional print head 5 (see FIG. 2) in a printer 1 (see FIG. 1) that uses a roll of paper RP (see FIG. 2) has a resolution of 203 dpi. In contrast, the print head 5 of the present embodiment has a resolution of 300 dpi, which is higher than the conventional resolution. This has the advantageous effect of making it possible to print more characters on the same area of paper as compared to when a print head 5 with a typical resolution is used.

On the other hand, the characters printed by the printer 1 using the print head 5 with a high resolution are smaller than those printed by a printer 1 with a typical resolution. For this reason, there is a need to print characters of the same size as those printed at a typical resolution even in the printer 1 using the print head 5 with a high resolution. In order to meet this need, it is conceivable to store enlarged fonts in addition to normal fonts in a memory such as the ROM 13 (see FIG. 4), and print, using the enlarged fonts, characters of the same size as those printed at a typical resolution. However, there are problems that, in order to store enlarged fonts in the memory, the enlarged fonts need to be purchased, and storing the fonts reduces the amount of data available in the memory by the amount of the enlarged fonts stored.

In contrast, in the printer 1 of the present embodiment, a normal font as illustrated in the upper left of FIG. 6 is tripled as illustrated on the right side of FIG. 6, and then halved as illustrated in the lower left of FIG. 6, making it possible to print the character of almost the same size as 203 dpi even using the print head 5 with a 300 dpi. This eliminates the need to purchase enlarged fonts and add them to the memory, and prevents a reduction in available memory capacity. In addition, since the font is multiplied by an integer (triple in the present embodiment) and then multiplied by an integer fraction (half in the present embodiment), the computation load on a processing device can be reduced as compared to multiplying the font directly by a non-integer multiple (one and a half times in the present embodiment). In FIG. 6, an example of enlarging the letter “H” by one and a half times is illustrated. It goes without saying that various characters other than “H”, such as European letters, Chinese characters, Japanese syllabaries, and numbers, can also be enlarged in the same way. The example illustrated here is of a base font being enlarged by one and a half times. However, a font of any desired magnification can be generated by enlarging or reducing the base font.

According to the printer 1 of the present embodiment described above, the movable blade 621 advances from the adhesive surface side of the linerless label paper LP toward the fixed blade 61 so that the surface of the movable blade 621 on the downstream side faces the surface of the fixed blade 61 on the upstream side. Therefore, even if the linerless label paper LP is cut multiple times, the adhesive is less likely to adhere to the surface of the movable blade 621 on the upstream side. As a result, without the need for a device for applying an expensive coating on the movable blade 621 or applying oil to the movable blade 621, the risk of the leading end of the uncut portion sticking to the adhesive that has adhered to the movable blade 621 is reduced and the occurrence of paper jams is suppressed. The adhesive adheres to and accumulates on the surface of the movable blade 621 on the downstream side, which faces the fixed blade 61 during cutting, and the resulting adhesive may stick to the adhesive surface at the trailing end of the cut portion. However, since the user of the printer 1 removes the cut portion from the printer 1, there is no problem of paper jam. In addition, since the fixed blade 61 is positioned on the printing surface side of the linerless label paper LP, the adhesive is less likely to adhere to the fixed blade 61. Even when the adhesive adheres to the surface of the fixed blade 61 on the upstream side and sticks to the uncut portion, the printed surface of the uncut portion simply sticks to the adhesive that has adhered to the fixed blade 61, so that its adhesive strength is much weaker than when the adhesive surface sticks to the adhesive. Therefore, the feeding backward after cutting by the cutting device 6 makes it easy to release the sticking.

In the case of feeding the linerless label paper LP, there is a risk that, when the uncut portion is fed to the downstream side from the cutting position before the cut portion is removed from the printer 1, the cut portion and the uncut portion being fed may stick together, causing a paper jam. According to the present embodiment, in the case of feeding the linerless label paper LP, it is detected that the cut portion has been removed from the printer 1 and then the uncut portion is fed to the downstream side from the cutting position, so that the occurrence of paper jams can be more reliably suppressed. Furthermore, since the linerless label paper LP is interposed between the print head 5 and the platen roller 8, the leading end of the uncut portion does not move unintentionally to the downstream side from the movable blade 621. This makes it possible to prevent the adhesive that has adhered to the surface of the movable blade 621 on the downstream side from sticking to the adhesive surface of the uncut portion. In addition, the linerless label paper LP that has been pulled out from the roll of paper RP, which is wound with the adhesive surface facing inward, tends to curve in a direction toward the adhesive surface as it runs toward its leading end, so that the leading end portion of the uncut portion is easily separated from the fixed blade 61. Therefore, even when the adhesive adheres to the downstream surface of the fixed blade 61, the adhesive that has adhered to the fixed blade 61 is prevented from sticking to the uncut portion.

The present invention is not limited to the embodiment described above, and various modifications may be applied thereto within the scope set forth in the aspects. For example, the print head 5 used in the present embodiment is a thermal type, but a print head of another type, such as an impact dot type, may be used. The cutting device 6 used in the present embodiment is a so-called guillotine-type electric cutter in which the movable blade 621 moves in parallel toward the fixed blade 61, but a scissors-type cutter in which the movable blade 621 moves rotationally may be used. Furthermore, instead of the platen roller 8, a platen having another shape, such as a plate-like shape, may be used. Moreover, a configuration may be provided in which a feed roller that is rotated by a motor is added in addition to the platen roller 8. In this case, a feed roller may be added on the downstream side from the cutting device 6. In addition, other treatment may be applied to make the paper less likely to stick to members of the paper feed path on the downstream side from the cutting position, such as attaching a non-adhesive film to the constituent members. Such treatment makes it difficult for the adhesive to stick to the constituent members, so that it is possible to prevent the adhesive accumulated on the movable blade 621 from being transferred to and sticking to the constituent members. Even if the adhesive does stick to the constituent members, it will adhere to the cut portion and peel off, allowing it to be quickly removed from the constituent members. Minute irregularities may be provided in a specific area on the surface of the movable blade 621 on the downstream side. By configuring so, the adhesive that has adhered to the movable blade 621 can be accumulated in the area where the irregularities are provided. In addition, since the adhesive is accumulated in the specific area, the adhesive accumulated on the movable blade 621 can be easily removed when the cutting device 6 is maintained. It is preferable that the irregularities to be provided on the surface of the movable blade 621 are formed at a distance of 0.6 mm or more away from the cutting edge of the movable blade 621. Positioning the irregularities in this way makes it possible to prevent the adhesive from adhering to the cutting edge, thereby preventing the adhesive that has adhered from adversely affecting cutting performance. Instead of such minute irregularities, other shape features or members that facilitate removal of the adhesive may be provided at a distance of 0.6 mm or more away from the cutting edge of the movable blade 621.

Even constituent elements included only in the descriptions of the modified examples described above may be applied to other modified examples.

What is claimed is:

1. A printer comprising:
a feeding means configured to feed paper having an adhesive surface on a side opposite to a printing surface on which printing is to be performed, the adhesive surface being coated with an adhesive;
a print head configured to perform printing on the paper being fed by the feeding means; and
a cutting device having a fixed blade and a movable blade,
wherein the movable blade advances from the adhesive surface side of the paper toward the fixed blade, and a surface of the movable blade on a downstream side in a paper feed direction faces a surface of the fixed blade on an upstream side in the paper feed direction.

2. The printer according to claim 1, further comprising a detection means positioned on the downstream side from a cutting position by the cutting device and configured to detect whether or not a cut portion of the paper cut by the cutting device has been removed from the printer, wherein the feeding means is configured to feed an uncut portion of the paper toward the downstream side from the cutting position after the detection means detects that the cut portion has been removed.

3. The printer according to claim 1, wherein
the feeding means has a platen positioned facing the print head, and
the print head is configured to perform printing on the paper that is interposed between the print head and the platen.

4. The printer according to claim 2, wherein
the feeding means has a platen positioned facing the print head, and
the print head is configured to perform printing on the paper that is interposed between the print head and the platen.

5. The printer according to claim 1, wherein the feeding means is configured to feed the paper pulled out from a roll of paper wound with the adhesive surface facing inward.

6. The printer according to claim 2, wherein the feeding means is configured to feed the paper pulled out from a roll of paper wound with the adhesive surface facing inward.
